(19) United States
(12) Patent Application Publication
(10) Pub. No.: US 2009/0019886 A1
(43) Pub. Date: Jan. 22, 2009

(54) Method and Apparatus for liquefaction of a Gas

(75) Inventors: Scott Willen, Boulder, CO (US); Charles J. Harmon, Boulder, CO (US); Richard J. Kocinski, North Huntingdon, PA (US)

Correspondence Address: Beck & Thomas, P.C.;SUITE 100, 1575 McFARLAND ROAD, PITTSBURGH, PA, 15216-1808, US

(73) Assignee: Inspired Technologies, Inc.

(21) Appl. No.: 12/124,352

(22) Filed: May 21, 2008

Related U.S. Application Data
(60) Provisional application No. 60/951,072, filed on Jul. 20, 2007.

(51) Int. Cl. F25J 1/02; F17C 3/02

(52) U.S. Cl. 62/606; 62/616; 62/49.2; 62/51.1

(57) ABSTRACT

A method and apparatus for making noncommercial amounts of a gas a liquid using a Joule-Thomson device. The device uses a precooler, a compressor, a Joule-Thomson valve and a thermally insulated housing.

### CROSS REFERENCE TO A RELATED APPLICATION

This application claims the benefit of U.S. Provisional Application No. 60/951,072 filed Jul. 20, 2007 which is hereby incorporated by reference in its entirety.

### BACKGROUND OF THE INVENTION

1. Field of the Invention

This invention relates to the production and storage of liquefied gas for small quantity uses.

2. Description of the related art

There are a growing number of individuals over 55 years old that through disease or long-term environmental exposure to inhaled particulate are unable to sufficiently oxygenate themselves with 21% oxygen (ambient air). These individuals are prescribed a stationary source and also a portable source of medical grade oxygen which is typically between 85-100% oxygen in order to raise blood O₂ levels to a normal range (>90% SaO₂). Home oxygen therapy is the primary treatment method.

The provider's role upon discharge from the physician is to provide oxygen therapy to patients in the home. They typically supply a concentrator for stationary use and either a liquid O₂ portable or a set of compressed gas cylinders for ambulatory use. Traditionally the physicians have preferred to prescribe highly portable liquid oxygen but high replenishment costs have pushed providers to supply gas in cylinders. Patient ambulation hours drive use of the oxygen contents stored in the portable and impact provider delivery frequency. The more frequent deliveries drive costs up and reduce profit for oxygen providers.

In order to solve this problem small scale Liquefiers that produce and store daily ambulatory O₂ requirements for individuals as liquid oxygen are needed. The small scale Liquefiers in combination with an Oxygen Concentrator would eliminate the need for deliveries of liquid O₂.

For many years large scale commercial gas liquefaction plants have existed. Generally the commercial plants operate on the scale of tons per day liquid cryogen production. Scaling down these gas liquefaction plants that produce tons of liquid cryogen per day, to less than 10 kg per day for an individual, is not feasible utilizing the same cooling process. Key components of the large scale cannot be reduced in size without severe performance penalties.

In order to use a typical commercial Joule-Thomson type device on a small scale one would have to provide a pressure of 340-350 atm. However, this type of Joule-Thomson device with a compressor would use a lot of power to operate and would be expensive. Additionally, the amount of pressure being used in this type of device makes it dangerous.

Typically, Joule-Thomson devices that produce liquid gas on a small scale give very low yield. A person of ordinary skill in the art would expect a typical Joule-Thomson apparatus to convert up to 5%-12% of the gas to a liquid.

There is need for a low pressure, low flow rate, and low power consuming Joule-Thomson type of device for producing non commercial amounts of liquid gas.

Another type of device that has been used to create liquid gas is a cryocooler. Although this approach has seen limited use in laboratory application, it has yet to be broadly applied for commercial applications because of the relatively high cost, limited lifetime, and low reliability of cryocoolers. Small-scale in-home oxygen liquefaction for medical use has been previously approached by utilizing a cryocooler to perform direct liquefaction of enriched oxygen. A small-scale in-home cryocooler device can be seen in U.S. Pat. No. 6,212,904 entitled Liquid Oxygen Production to Arkharov et al. This device has high costs because of the cryocooler component and as mentioned previously the cryocoolers have low reliability.

### BRIEF SUMMARY OF THE INVENTION

This invention provides for a Joule-Thomson apparatus for producing non commercial amounts of a liquid gas. The apparatus has a compressor that takes a gas from a feed source and creates a high pressure gas stream and a precooler that cools the high pressure gas stream to a temperature in the range of 145-185 degrees Kelvin (−128.15-88.15 degrees Celsius). The temperature could be from 165-185. A heat exchanger cools the high pressure gas stream. A Joule-Thomson expansion device receives the high pressure gas stream and expands the compressed gas to create a liquid gas. A thermally insulated housing that contains a reservoir for storing the liquid gas receives the liquid gas.

The heat exchanger and the Joule-Thomson can be within the thermally insulated housing. The refrigerant can also be within the housing.

The precooler can be a cascade refrigerator that uses ethylene as a refrigerant. The Joule-Thomson can produce both a gas phase and a liquid phase. A return path can be included for the gas phase to be used in cooling the incoming gas from the feed source, the gas phase can also be recycled through the apparatus. The return path can include a vent in the reservoir that takes the gas from the reservoir back to the compressor inlet where it is combined with gas from the feed source. A regulator can limit the flow rate of the gas from the feed source to the amount of flow from the feed source not being used for therapy by the patient.

A boost compressor that can be used to maintain the liquid pressure between 10 and 25 psig.

A second heat exchanger and a third heat exchanger can be connected to the first heat exchanger; all three heat exchangers are located within the thermally insulated housing. The high pressure gas flows through the first heat exchanger and then the second heat exchanger where it is cooled by the precooler and then finally cooled by the third heat exchanger all prior to entering the Joule-Thomson device.

The gas used is preferably a medical gas. Most preferably the gas is oxygen.

The object of this invention is to provide a Joule-Thomson device that produces less than 10 kg per day of a liquid gas.

This invention also provides for a method of producing noncommercial amounts of a liquid from a gas. A gas is provided and compressed from 80 to 120 atm (1176 to 11764 psi) (8106 to 12159 kpa). The compressed gas is precooled to a temperature in the range of 145-185 degrees Kelvin (−128 to −88 degrees Celsius). The compressed and cooled gas is then introduced to the Joule-Thomson expansion device whereby the gas is expanded to create a liquid gas. This method can produce greater than 25% of the gas being liquefied. The gas being liquefied is preferably a medical gas and most preferably is oxygen.

This invention also provides for a dewar assembly. The dewar has a thermally insulated housing. A heat exchanger is located within the thermally insulated housing and cools a high pressure gas stream entering the housing. A Joule-Thomspon expansion device that expands gas to create a liquid gas is within the thermally insulated housing. The thermally insulated housing also has a reservoir to store the liquid gas created by the Joule-Thomson device.

The disclosed invention describes a system for small scale liquefaction of gases system that is based upon a precooled Joule-Thomson (JT) expansion process. It generally includes one or more compressors, a heat exchanger assembly, a low-temperature precooler, a desiccant assembly, a Joule Thomson valve and filter assembly, various flow control components, a mechanism to withdraw and transfer the liquid cryogen to a receiver vessel, and an insulated dewar that contains a reservoir for collecting and storing the liquid cryogen.

The gases that can be liquefied by the herein described apparatus include, but are not necessarily limited to nitrogen, argon, oxygen, and methane. In the preferred embodiment, the disclosed system can be used to produce and store liquid oxygen from a gaseous oxygen feed source for persons that require supplemental oxygen for breathing disorders or lung diseases such as chronic obstructive pulmonary disease (COPD). It provides a mechanism to transfer the stored liquid oxygen to a small, commercial portable liquid oxygen breathing device that the patient can take with them for oxygen therapy. It also contains a mechanism for the patient to attach a canula tube and breathe directly off the aparatus.

### BRIEF DESCRIPTION OF THE SEVERAL VIEWS OF THE DRAWINGS

FIG. 1 depicts the in-home or office set up of the gas liquefaction system including its associated supporting equipment.

FIG. 2 is a block diagram identifying the major components of the gas liquefaction system.

FIG. 3 is a schematic diagram showing the flow of gas through the gas liquefaction system and all flow control components.

FIG. 4 shows the heat exchanger assembly consisting of three distinct heat exchangers integrated into a single, high-effectiveness assembly.

FIG. 5 Shows the Joule-Thomson valve.

FIG. 6 Shows the integrated dewar assembly that includes the heat exchanger assembly, Joule-Thomson valve and the storage reservoir.

FIG. 7A is a thermodynamic diagram illustrating the method for gas liquefaction.

FIG. 7B is a thermodynamic diagram illustrating the method for gas liquefaction.

FIG. 8 Second embodiment showing the heat exchanger assembly and Joule-Thomson/filter assembly located in a separate insulated assembly form the storage reservoir.

### DETAILED DESCRIPTION OF THE INVENTION

### Definitions

“noncommercial amounts”—typically would be about less than 10 kg per day. However, it would be any amount that is not made for commercial production.

“a compressor”—a mechanical device that increases the pressure of a gas by reducing its volume.

“takes a gas from a feed source”—receives gas from the originating component

“a gas”—a fluid (as air) that has neither independent shape nor volume but tends to expand indefinitely. Another example would be O₂(oxygen).

“feed source”—something that supplies the gas. This could be a gas concentrator such as an oxygen concentrator. This can be an external unit or it can be an internal unit built into the liquefier.

“creates a high pressure gas stream”—taking a feed gas and increasing the pressure. The pressure is typically increased to between 80-120 atm (1176 to 11764 psi) (8106 to 12159 kpa).

“a precooler”—A device for reducing the temperature of a working fluid before it is used by a machine.

“cools the high pressure gas stream”—reducing the temperature of the high pressure gas stream

“a temperature in the range of 145-185 degrees Kelvin”—Any temperature between 144.0 and 186 degrees Kelvin.

“a temperature in the range of 165-185 degrees Kelvin”—Any temperature between 164.9 and 186.0 degrees Kelvin.

“a Joule-Thomson expansion device”—A valve through which a gas is allowed to expand adiabatically, resulting in lowering of its temperature. 80-120 ATM dropping quickly to 1.5-2.0 ATM quickly. 0.002″ diameter orifice but can be varying length and diameter.

“receives the high pressure gas stream”—taking the high pressure gas stream

“expands the compressed gas to create a gas”—using the Joule-Thomson effect to take a gas and turn it into a liquid

“thermally insulated housing”—a container made like a vacuum bottle that is used especially for storing liquefied gases. 2 liquid liters (inner) assembly wrapped with insulation, encased in outer welded section, heat and vacuum applied having a pump out port.

“a reservoir for storing the liquid gas”—a compartment for keeping a liquid gas so that it remains a liquid gas.

“within a thermally insulated housing”—Anywhere within the housing. It could be within a first wall or a second wall.

“cascade refrigerator”—a system of two or more interrelated, and generally closed, refrigeration loops so arranged that the condensation of a primary refrigerant is effected by indirect heat exchange with evaporating secondary refrigerant and, if there are more than two loops, the condensation of the secondary refrigerant is effected by indirect heat exchange with evaporating tertiary refrigerant, and so on, whereby refrigerant temp is produced at progressively lower temperatures in the loops, the primary refrigerant being in the coldest loop. The preferred embodiment uses R404A refrigerant in the first stage and R1150 in the second stage. It can have a tube in tube interstage heat exchanger. The cascade refrigeration unit uses two vapor compression cycle refrigerators, the first feeding the second. Each stage has a refrigeration compressor, a refrigerant line with a capillary tube throttling valve internal to the outer tube. The first stage uses R-404A (Forane) refrigerant and brings the temperature down to approximately −50° C. The output of the first stage is fed to an interstage heat exchanger that can be either stacked plate or tube-in-tube style. The second stage vapor-compression cycle uses R-1150 as a refrigerant and then cools to approximately −100° C.

“cascade refrigerator using R1150 as a refrigerant”—a cascade refrigerator that uses R1150 refrigerant.

“gas phase”—part of the fluid from the Joule-Thomson device that is in the form of a gas

“liquid phase”—the major component of the fluid from the Joule-Thomson is in the form of a liquid

“a return path for the gas phase to be used in cooling the incoming gas from the feed source”—a vent and tube used to direct the gas to the feed source.

“recycled through the apparatus”—to pass again through the device

“a vent”—an opening for the escape of a gas or liquid

“takes the gas from the reservoir back to the compressor”—transports the gas phase back to the compressor

“combined with gas from the feed source”—to unite the gas from the feed source with

“regulator that a flow rate of the gas from the feed source to amount of flow from the feed sources not being used for therapy by the patient”—a control that can alter the flow of gases to the amount required by the patient.

“boost compressor”—compressor that increases a pressure. KDF Neuberg O₂ Compressor can be used. The model UN86 pump with a 24V BLDC motor has been modified to generate 8 LPM free-flow, a maximum pressure of 45 psi, and 22.6 in. Hg of end vacuum and features logic-controlled speed control and remote logic on-off. A 120 V shaded pole motor instead of a 24V motor is used. The part number is UN86KTI, 15V/60 Hz.

“between 10 and 25 psig”—from 9.9 psig to 26 psig

“medical gas”—a gas used for medical purposes. This would include methane, oxygen, nitrogen, nitric oxide, neon and krypton.

“Oxygen”—This is understood to be an oxygen enriched gas. It can be mostly oxygen gas. The gas can have an oxygen content greater than or equal 85% oxygen and the rest be nitrogen or other gas or gases.

“including a second heat exchanger and a third heat exchanger”—two additional heat exchangers in addition to the first heat exchangers.

“providing a gas”—supplying a gas from any source

“compressing the gas to a pressure from 80-120 atm”—reducing the volume of a gas so that it has a pressure between 79 to 121 atm.

“providing a Joule-Thomson device”—supplying a device that uses the Joule-Thomson effect to change a gas from a liquid

“precooling the compressed gas to a temperature in the range of 165-185 degrees Kelvin”—lowering the temperature of the compressed gas to any temperature greater than 164 degrees Kelvin and less than 186 degrees Kelvin.

“introducing the cooled gas to the Joule-Thomson expansion device”—transporting the cooled compressed gas to the Joule Thomson expansion device.

“greater than 25% of the gas is liquefied”—at least twenty-five percent of the volume of gas being provided is converted to liquid.

“insulated housing”—a device that prevents changes in temperature.

### Description

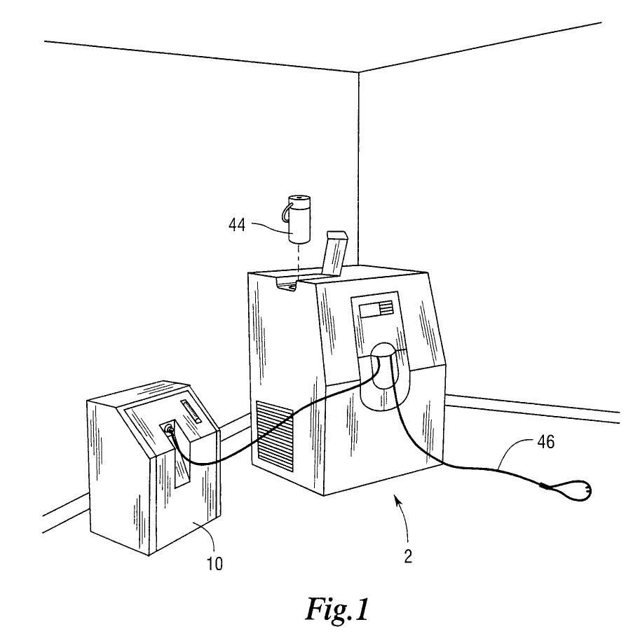

A methodology and apparatus for the liquefaction, storage, and transfer of liquefied gases is disclosed. In the preferred embodiment as described herein, the gas liquefied is oxygen. With respect to FIG. 1, the Joule-Thomson apparatus 2 for producing and storing liquid oxygen is supplied with gaseous oxygen from any commercially available feed source 10 which in FIG. 1 is an oxygen concentrator. The Joule-Thomson apparatus 2 preferably produces around 10 kg per day of liquid gas. A port 44 for attaching a cannula tube that allows a patient to breathe directly off the apparatus is provided and a port 46 for withdrawing the liquid oxygen to fill a commercially available portable liquid oxygen breathing unit is provided. This does not preclude using any gaseous oxygen feed source with purity above 85%. Any suitable liquid oxygen receptacle that can be adapted to receiving liquid oxygen from the apparatus can also be used.

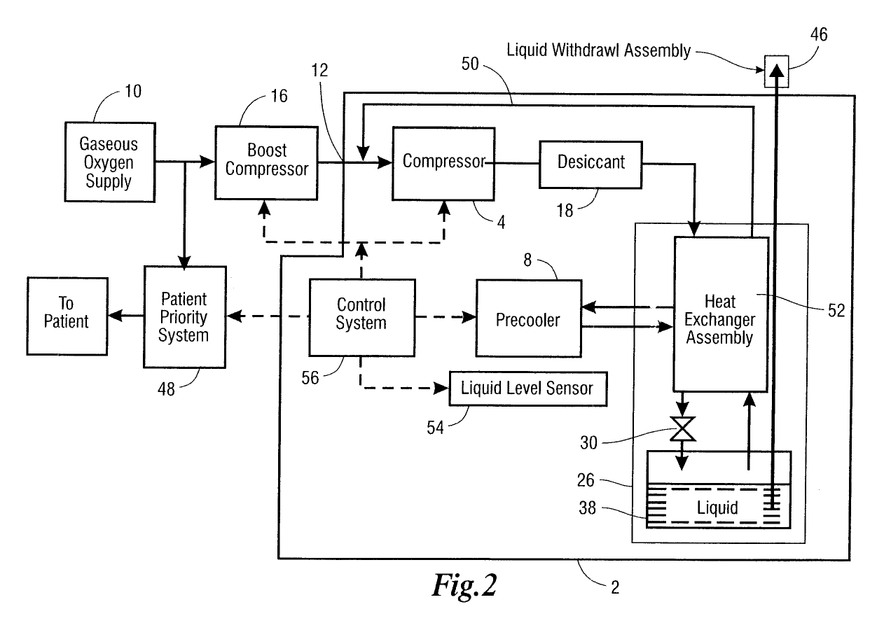

FIG. 2 shows the major components of the invention and their interrelationship. The feed source 10 can be a gas concentrator that takes air and produces the desired gas. Preferably, the gas would be a medical gas such as oxygen. Typically the feed source 10 for oxygen would be an oxygen concentrator that feeds the patient priority system 48 which divides the flow to the patient and the boost compressor 16. For the remaining part of the description the gas will be oxygen even though it is understood that other gases could be liquefied. The patient priority system 48 can be manually adjusted to deliver a fixed gaseous flow rate to the patient regardless of whether the Joule-Thomson apparatus 2 is operating or non-operating. The remaining gaseous oxygen is available to the boost compressor 16. The patient priority system 48 allows the flow from the concentrator to be split between a patient's needs, and the liquefier. This system places the preference on the patient so as to use the excess flow for the liquefier. The concentrator is capable of 5 LPM output. Most patients are on a 2 LPM setting (85% of all patients), which leaves 3 LPM to be liquefied. In the event that the patient turns the output knob to 3 LPM, the liquefier will be limited to 2 LPM for liquefaction.

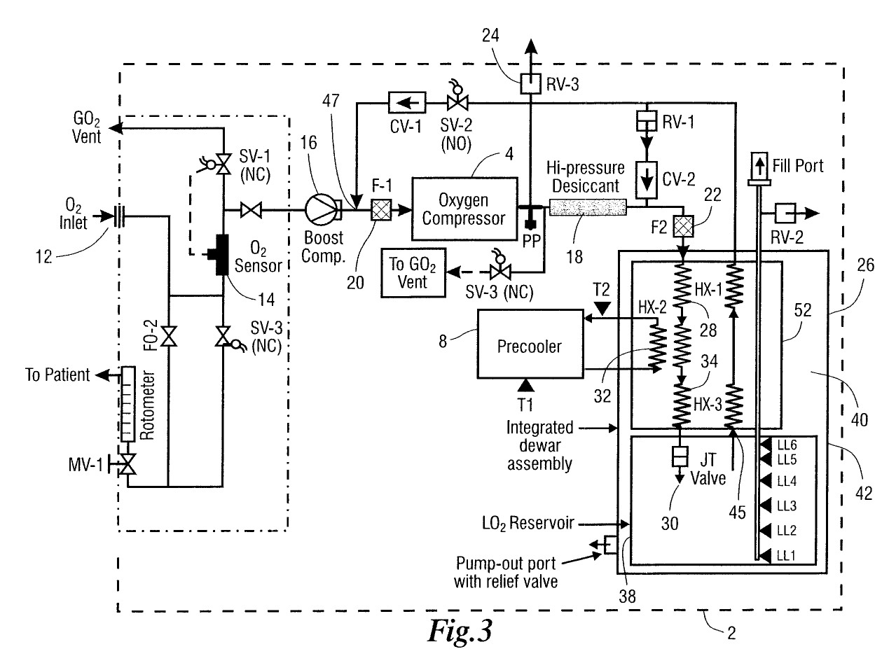

The oxygen source is fed into the unit and is first analyzed by an oxygen sensor. If the oxygen purity is below 88%, then valve SV-1 (shown in FIG. 3) is opened and all of the gas is vented out. It is neither used for the patient, nor for liquefaction. If the incoming gas is >88%, then SV-1 is closed and the gas is fed to the patient and to the liquefier. In order to maintain stable flow to the patient independent of the boost compressor being on or off, a series of orifices are used to limit flow. NV-1 is set up to limit the flow to the boost pump and prevent it from starving the patient flow when the boost pump is turned on. When the boost pump is on, SV-3 is opened to bypass needle valve NV-2. When the boost pump is off, SV-3 is closed and flow is routed through NV-2 to provide balanced flow. In this manor, the throttled flow is matched whether the boost pump is on or off, and the patient flow remains consistent. When a patient sets the flow to 2 LPM, this is provided and remains stable for the patient.

The boost compressor 16 can either be a stand-alone single-stage compressor or the first stage of the compressor 4. Oxygen from the boost compressor 16 is combined with oxygen gas vented from the liquid storage reservoir 38 that flows through the return path 50 and then directed to the compressor 4.

A desiccant assembly 18 located downstream of the compressor 4 removes almost all the moisture from the high-pressure oxygen stream. A thermally insulated housing 26 which can be a dewar contains a heat exchanger assembly 52, a Joule-Thomson valve 30, liquid cryogen reservoir 38, and a port 46 for withdrawing the liquid cryogen from the reservoir 38. A precooler 8 supplies refrigerant to the heat exchanger assembly 52 used to precool the high-pressure oxygen stream. Attached to the port 46 is a sensor board for measuring the liquid level within the reservoir 38 and transmitting the signal to the liquid level sensor assembly 54. A control subsystem 56 receives inputs from the active system components and liquid reservoir and it provides information on and controls the operation of the Joule-Thomson apparatus 2.

FIG. 3 shows a diagrammatic view of the Joule-Thomson apparatus 2. Oxygen gas is provided from a feed source 10. The feed source 10 typically would be an oxygen concentrator that uses air to produce oxygen. The feed source 10 could alternately be oxygen from a tank.

Gas from the feed source 10 enters the Joule-Thomson apparatus 2 at inlet 12. In one embodiment the gas can travel through a gas sensor 14 that senses the concentration of the gas from the feed source 10. If the gas is oxygen and the apparatus is equipped with the gas sensor 14 it will sense if the oxygen level is less than 88% and if so it will open a solenoid valve and let the gas vent off. A potential impurity for oxygen is nitrogen. The gas may or may not travel through a boost compressor 16. The boost compressor 16 compresses the feed gas to a pressure between 10 and 25 psig (170.3 kpa and 273.7 kpa)

The gas can then pass through a filter 20. The filter can be a 2μ sintered metal stainless steel filter. After passing through the filter 20 the gas flows to the compressor 4 where it is compressed to a pressure up to 1800 psig (12530 kpa) or to a range of 80-120 atm. The high-pressure gas flows through the desiccant assembly 18, which reduces its dew point to less than −100° C. (173.15 K), then into the heat exchanger assembly 52 located within the thermally insulated housing 26. The compressed oxygen can travel through an optional second filter 22 prior to entering the thermally insulated housing 26. An optional relief valve 24 can also be present.

After being compressed the oxygen travels into the thermally insulated housing 26. The thermally insulated housing 26 has an inner portion 40 and an outside wall 42. The compressed oxygen then travels to a first heat exchanger 28 within the thermally insulated housing 26. The first heat exchanger 28 reduces the temperature of the high-pressure flow approximately 50° C. The goal is to get the oxygen to a temperature of less than 165 K prior to entering a Joule-Thomson valve. This can be accomplished by a single heat exchanger or three heat exchangers and/or a precooler or any combination of those components. The preferred embodiment uses the first heat exchanger 28 a second heat exchanger 32 and a third heat exchanger 34 in combination with a precooler 8. After the gas flows through the first heat exchanger 28 it then flows through the second heat exchanger 32 and is cooled to approximately −105° C. to −100° C. (168.15 to 173.15 K) by the precooler second stage evaporator. The third heat exchanger 34 provides additional cooling of the high-pressure gas to about −105° C. to −110° C. (168.15 to 163.15 K) just before it is expanded through the Joule-Thomson valve 30. During the expansion of the cold, high-pressure gas to approximately 20 psig (239.2 kpa), about 35% of the gas is liquefied; the remainder is vented through the third heat exchangers 34 and the first heat exchanger 28 where it is warmed to room temperature by providing the cooling to the inlet high-pressure gas. Reservoir 38 has a gas phase. A vent 45 within the reservoir 38 takes the gas phase from the reservoir 38 back to the compressor 4 at return path inlet 47 where it is combined with more feed gas replace the gas that was liquefied.

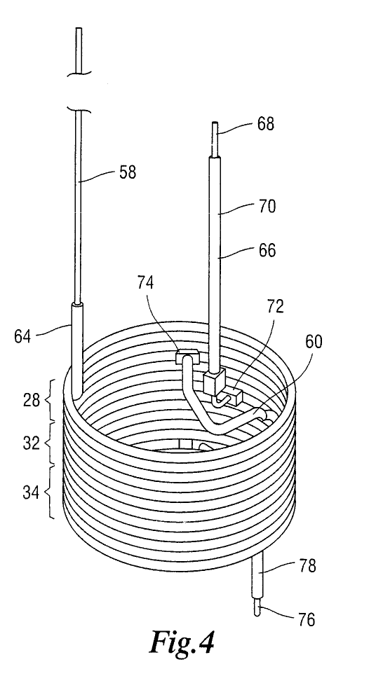

To achieve the large liquid yield, the disclosed apparatus employs a high-effectiveness tube-in-tube heat exchanger assembly 52 depicted in FIG. 4. In the preferred embodiment, this assembly combines three distinct heat exchangers into a single unit. A small-diameter, continuous tube 58 contains the high-pressure gas that flows from the compressor 4 through all three heat exchangers and to the Joule-Thomson valve 30. Continuous tube 58 can be ⅛ inch diameter. A larger diameter concentric outer tube 64, concentric with the inner continuous tube 58, contains the low-pressure return flow (i.e., vent gas) from the cryogenic liquid reservoir 38 that cools the high-pressure gas in the third heat exchanger 34 and in the first heat exchanger 28. The vent gas exiting the third heat exchanger 34 is routed around the second heat exchanger 32 through a jumper tube 60 that connects it to the first heat exchanger 28 by tube fittings 72 and 74. The low-pressure return gas exits the heat exchanger assembly near room temperature through the outer concentric tube 64.

Second heat exchanger 32 uses a two-phase refrigerant flowing through the annular space for cooling the high-pressure gas stream to a temperature around −105° C. to −100° C. (168.15 to 173.15 K). The inlet manifold 66 consists of a small-diameter refrigerant inlet tube 68 that the refrigerator second-stage capillary tube is inserted, a concentric outer inlet tube 70 through which the evaporated refrigerant gas is returned to the refrigerator second-stage compressor, and first fitting 72 and second fitting 74 that connect the inlet manifold 66 to the second heat exchanger 32.

The cold, high-pressure outlet 76 of the third heat exchanger 34 is attached to the Joule-Thomson valve 30; the low-pressure return flow from the cryogenic liquid reservoir 38 enters the annular space between the inner and outer third heat exchanger tube 78.

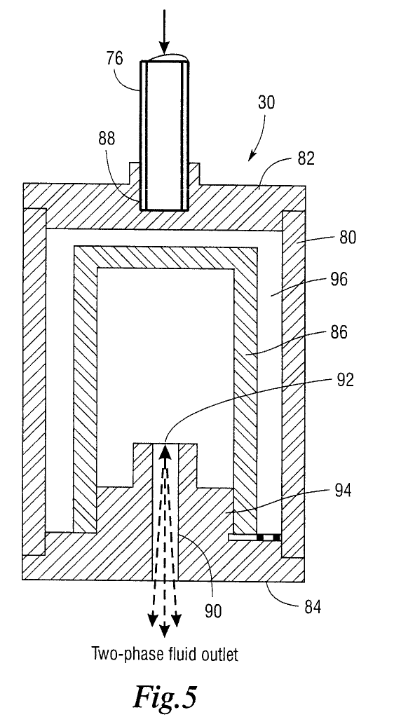

FIG. 5 shows the Joule-Thomson valve 30 which is preferably 1.5 inches. The Joule-Thomson valve 30 has a cylindrical tube section 80 enclosed by a top end cap 82 and bottom end cap 84. The Joule-Thomson valve 30 also has a micro porous filter element 86. The top end cap 82 has a pocket 88 machined into it for attachment of high pressure outlet 76. The bottom end cap 84 has a small diameter cavity 90 bored nearly through the structure. A small diameter orifice 92 is bored through the thin material at the interior end of the cavity 90. The orifice 92 can be mechanically drilled, laser drilled, or electro magnetically drilled. In the preferred embodiment, barbs 94 machined into the bottom of end cap 84 provide a mechanism for holding the micro porous filter element 86 in place. Annular space 96 between the filter element 86 and cylindrical tube section 80 provide a moisture trap wherein any moisture that migrates to the Joule-Thomson valve 30 assembly will freeze out and become trapped, preventing an ice plug from blocking the orifice 92.

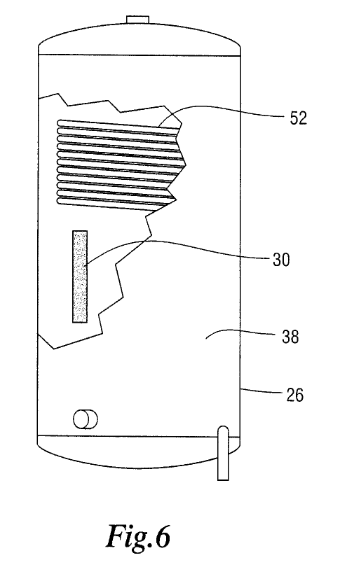

FIG. 6 shows the heat exchanger assembly 52, Joule-Thomson valve 30, and the liquid storage reservoir 38 are all housed within a thermally insulated housing 26. The thermally insulated housing shown is a common vacuum insulated dewar. The high-pressure supply gas from the compressor 4 enters the heat exchanger assembly 52 where it is cooled to below approximately −110° C. (163.15 K), is expanded through the Joule-Thomson valve and the liquefied gas is collected in the reservoir 38 while the vapor exits through the heat exchanger assembly 52.

Alternately, the first heat exchanger 28, the second heat exchanger 32, and the third heat exchanger 34 and reservoir 38 can be housed separately in any combination should operational or packaging considerations motivate such placement.

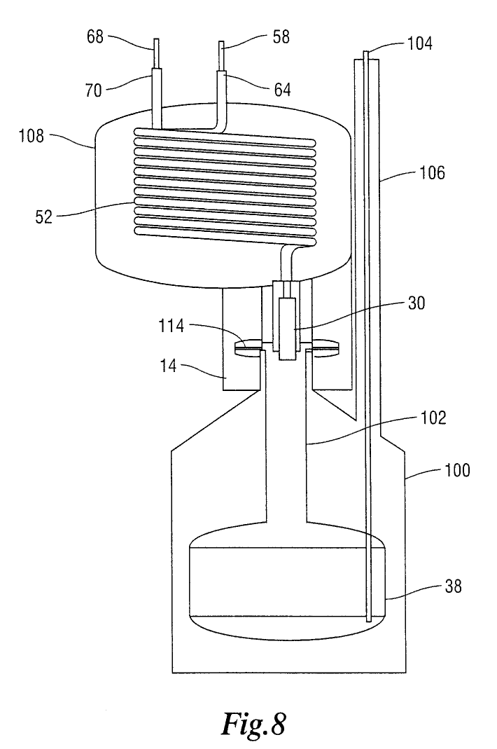

FIG. 8 shows a split dewar assembly. The liquid oxygen reservoir 38 is within liquid oxygen vacuum insulated dewar 100. There is a liquid oxygen storage reservoir support tube 102 that connects with the joule Thompson valve 30. Extending from the liquid oxygen reservoir 38 is the liquid oxygen withdrawal tube 104 and the liquid oxygen withdrawal shroud 106. Heat exchanger assembly 52 is housed within heat exchanger assembly insulated vacuum shell 108. A small-diameter, continuous tube 58 contains the high-pressure gas that flows from the compressor 4 through all three heat exchangers and to the Joule-Thomson valve 30. Continuous tube 58 can be ⅛ inch diameter. A larger diameter concentric outer tube 64, concentric with the inner continuous tube 58, contains the low-pressure return flow (i.e., vent gas). A small-diameter refrigerant inlet tube 68 and a concentric outer inlet tube 70 through which the evaporated refrigerant gas is returned to the refrigerator extend from the heat exchanger vacuum shell 108. There is also a vacuum flange 114 between the heat exchanger vacuum shell 108 and the liquid oxygen insulated dewar 100.

The reservoir 38 could be separable from the Joule-Thomson valve 30 and heat exchangers allowing the vacuum-jacketed reservoir 38 to become a removable and portable unit with the Joule-Thomson valve 30 and the first heat exchanger 28, the second heat exchanger 32, and the third heat exchanger 34 remaining a fixed part of the liquefier equipment. In this embodiment, the Joule-Thomson valve 38 and the first heat exchanger 28, the second heat exchanger 32, and the third heat exchanger 34 will be contained in a separate, thermally insulated housing. Insulation may be a vacuum with multilayer insulation (MLI) or other insulation material (vacuum or non vacuum) such as foam, microspheres, or aerogel suitable to achieve the desired thermal performance. Operating temperatures, pressures, liquefaction rate, and storage quantity are established for optimal performance of the system. System performance factors considered include but are not limited to: liquefaction rate, input power, reliability, noise, and ease of use. Liquefier component specifications dictate optimal values for these operating parameters. Alternate components with different specifications may be used when price/performance considerations allow an overall improvement in the LO₂ liquefier. One variation would involve an oxygen compressor with reduced outlet pressure (80 bar versus 110 bar). Such a compressor would potentially provide increased reliability, but would require a lower precooler 8 temperature for the second heat exchanger 32.

The oxygen preferably travels in a ⅛^{th} inch tube all the way to a Joule-Thomson valve 30. The Joule-Thomson valve 30 in a preferred embodiment is 1.5 inches. The first heat exchanger 28 is a ¼^{th} inch tube surrounding the ⅛^{th} inch tube. The first heat exchanger 28 takes the temperature from ambient temperature to around 245 K. The cooling for the first heat exchanger 28 can be provided from gas that has a temperature of 175 K to 180 K from the third heat exchanger 34. The gas then travels to the second heat exchanger 32 where it is reduced from 245 K to a temperature less than 180 K.

Finally, the oxygen travels through the third heat exchanger which reduces the temperature of the compressed gas to 165 K. The precooler 8 provides cooling within the thermally insulated housing to a temperature of between 165K-185K. The precooler 8 uses ethylene as a refrigerant.

Alternatively a mixed gas precooler can be used to allow to reach a temperature between 145-185 K. A mixed gas refrigeration unit can replace the two stage cascade refrigeration unit. A mixed gas cooling unit uses multiple gases cycling in the same lines and using only one refrigeration compressor in such a way as to reach lower temperatures. The use of one working fluid consisting of multiple refrigerants provides a variable boiling temperature. This mixed gas cycle can provide lower costs than cascade refrigeration since only one compressor is needed.

The Joule-Thomson device 2 as described above unexpectedly produces 5 times the yield of what a person of ordinary skill in the art would expect. A person of ordinary skill in the art would expect the yield of the typical Joule-Thomson device to be about 5-10%. 11-12% would be a good yield. This device yields 25%.

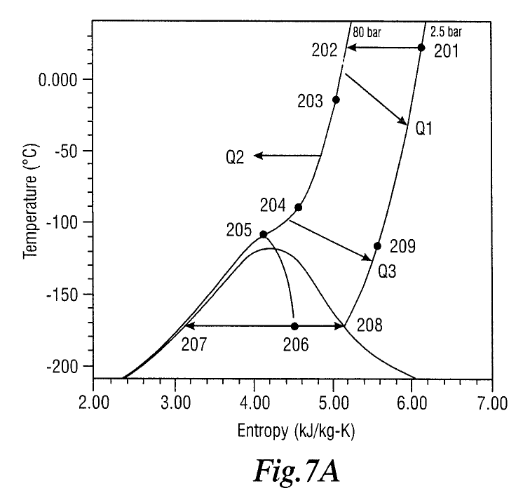

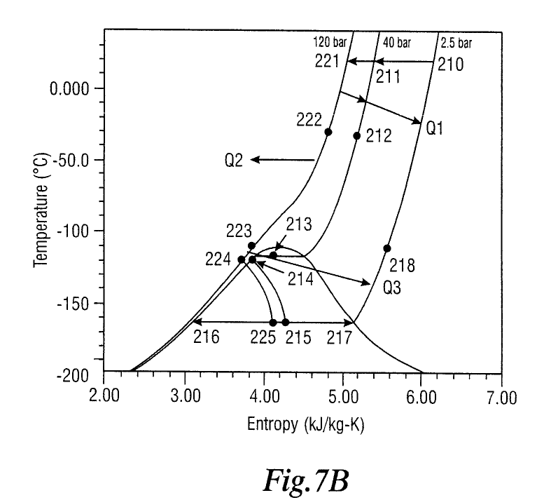

In FIG. 7A, the gaseous oxygen stream to be liquefied is compressed from a low pressure 201 to a pressure between 40 and 120 bar 202 (4000 kpa and 120000 kpa). It is then cooled 203 in a counterflow heat exchanger HX-1 by transferring heat Q1 to cold vent gas from the liquid oxygen storage reservoir. The cooled high-pressure gaseous oxygen stream flows through heat exchanger HX-2 where it is further cooled by an external precooler to a temperature between −80° C. and −150° C. (193 K and 123 K) 204. A final reduction in the high-pressure gaseous oxygen stream temperature 205 takes place in HX-3, where heat is transferred to the cold vent gas that has just exited the liquid oxygen storage reservoir.

The cold, high-pressure gaseous oxygen is then adiabatically expanded through a Joule-Thomson expansion valve producing a two-phase oxygen mixture of saturated liquid and vapor 206. The liquid 207 is accumulated and stored in an insulated reservoir and the vapor 208 is vented, ultimately back to the compressor. It is the cold vented vapor that absorbs the heat from the high-pressure gaseous oxygen stream in HX-3 (208 to 209) and in HX-1 (209 to 201). This cycle repeats itself with the addition of additional gaseous oxygen added at the compressor inlet 201 from a concentrator, or any other suitable gaseous oxygen source, to make up for the oxygen that has been liquefied.

FIG. 7B illustrates an alternate embodiment of the same cycle for the case where the precooling temperature is below the critical temperature of the gas being liquefied; for oxygen, that temperature is −118° C. (155 K). For compressor outlet pressures below the critical pressure of the gas being liquefied, 50.4 bar (5040 kpa) for oxygen, the path followed by the gas is 210-211-212-213-214-215-216-217-218-210. The high-pressure gas stream is liquefied, or partially liquefied, in the precooler heat exchanger HX-2. After the fluid exits HX-2 213, it is then it is cooled further in HX-3 214 before being adiabatically expanded through the Joule-Thomson valve 215. Using this variation on the basic liquefaction cycle shown by FIG. 8A, a greater fraction of the gas stream is liquefied.

For compressor outlet pressures above the critical pressure of the gas being liquefied, the path followed by the gas is 210-221-222-223-224-225-216-217-218-210. The fluid exiting the precooler heat exchanger HX-2 is a compressed liquid 223. After further cooling in HX-3 224, it is adiabatically expanded through the Joule-Thomson valve 225. For this variation, a larger fraction of the gas stream is liquefied over the case where the pressure is below the critical pressure of the gas.

It is to be understood that the various aspects of the disclosed design, components and hardware elements used for performing a function, and the operating parameters such as pressures, temperatures, volumes, and times can vary. Various changes could be made in the above construction and method without departing from the scope of the invention as defined in the claims below. It is intended that all matter contained in the above description including the definitions and as shown in the accompanying drawings shall be interpreted as illustrative and not as a limitation.

We claim:

1. A Joule-Thomson apparatus for producing noncommercial amounts of liquid gas comprising:
a. a compressor that takes a gas from a feed source and creates a high pressure gas stream;
b. a precooler that cools the high pressure gas stream to a temperature in the range of 145-185 degrees Kelvin;
c. a heat exchanger that cools the high pressure gas stream;
d. a Joule-Thomson expansion device that receives the high pressure gas stream and expands the compressed gas to create a liquid; and
e. a thermally insulated housing that contains a reservoir for storing the liquid gas.

2. A Joule-Thomson apparatus as recited in claim 1 wherein the precooler cools the high pressure gas stream to a temperature in the range of 165-185 degrees Kelvin.

3. An apparatus for making liquid gas as recited in claim 1 wherein the heat exchanger and the Joule-Thomson are within the thermally insulated housing.

4. An apparatus for making a liquid gas as recited in claim 1 wherein the precooler is a cascade refrigerator using ethylene as a refrigerant.

5. An apparatus as recited in claim 4 wherein the heat exchanger, the Joule-Thomson expansion device and the refrigerant are within the thermally insulated housing.

6. An apparatus as recited in claim 1 wherein the Joule Thomson device also creates a gas phase along with the liquid gas.

7. An apparatus as recited in claim 6 including a return path for the gas phase to be used in cooling the incoming gas from the feed source, the gas phase is also recycled through the apparatus.

8. An apparatus as recited in claim 7 wherein return path comprises:
a. a vent in the reservoir that takes the gas from the reservoir back to the compressor inlet where it is combined with gas from the feed source; and
b. a regulator that limits a flow rate of the gas from the feed source to the amount of flow from the feed source not being used for therapy by the patient.

9. An apparatus as recited in claim 1 including a boost compressor that supplies pressurized gas to the compressor.

10. An apparatus as recited in claim 1 wherein the gas is a medical gas.

11. An apparatus as recited in claim 10 wherein the gas is oxygen.

12. An apparatus as recited in claim 1 including a second heat exchanger and a third heat exchanger connected to the first heat exchanger, all three heat exchangers are located within the thermally insulated housing, the high pressure gas flows through the first heat exchanger and then the second heat exchanger where it is cooled by the precooler and then finally cooled by the third heat exchanger all prior to entering the Joule-Thomson device.

13. A method for producing noncommercial amounts of liquid per day comprising:
a. providing a gas;
b. compressing the gas to a pressure from 80-120 atm;
c. providing a Joule-Thomson expansion device;
d. precooling the compressed gas to a temperature in the range of 145-185 degrees Kelvin; and
e. introducing the compressed and cooled gas to the Joule-Thomson expansion device whereby the gas is expanded to create a liquid gas.

14. The method as recited in claim 12 wherein greater than 25% of the gas is liquefied.

15. The method as recited in claim 12 wherein the gas is a medical gas.

16. The method as recited in claim 12 wherein the gas is Oxygen.

17. A dewar assembly comprising:
a. a thermally insulated housing;
b. a heat exchanger within the thermally insulated housing that cools a high pressure gas stream that enters into the housing;
c. a Joule-Thomson expansion device within the thermally insulated that is used to expand gas that enters the housing in order to create a liquid gas; and
d. a reservoir within the thermally insulated housing for storing the liquid gas created by the Joule Thomson expansion device.
